(19) United States
(12) Patent Application Publication
(10) Pub. No.: US 2023/0185095 A1
(43) Pub. Date: Jun. 15, 2023

(54) DISPLAY DEVICES INCORPORATING METALENSES

(71) Applicant: Meta Materials Inc., Boxborough, MA (US)

(72) Inventor: Jonathan Waldern, Diablo, CA (US)

(21) Appl. No.: 18/077,989

(22) Filed: Dec. 8, 2022

Related U.S. Application Data
(60) Provisional application No. 63/288,485, filed on Dec. 10, 2021.
(60) Provisional application No. 63/311,929, filed on Feb. 18, 2022.
(60) Provisional application No. 63/337,012, filed on Apr. 29, 2022.

(51) Int. Cl. G02B 27/01; G02F 1/35

(52) U.S. Cl. CPC G02B 27/0172; G02F 1/3501; G02B 2207/101

(57) ABSTRACT

Disclosed are devices for displaying information, comprising: an optical substrate; display panels, for example micro LED display panels; metalens elements or lens groups; and a reflector that may comprise a reflection grating or reflection hologram. Also disclosed are methods for displaying information on a device.

### FIELD OF THE INVENTION

The present disclosure relates optical holography, and more specifically, to a display device incorporating metalenses.

### BACKGROUND OF THE INVENTION

Heads-Up Displays (“HUDs”) are compact transparent devices for displaying information without distracting users from their usual viewpoints. HUD combiners based on diffractive optical combiners have achieved compact form factors with reflection holographic optical elements (HOEs) being a known example.

Reflection HOEs use complex pupil expansion optics to achieve wide field of view (FOV) and large eye box.

Reflection HOEs can be manufactured as flat pierces for standalone combiners or with curved wavefront prescriptions enabling lamination onto windshields. Edge-lit reflection HOE solutions couple image light from a spatial light modulator, such as a microLED array or a laser scanner with pupil replication, into a holographic substrate at a steep incidence angle via an edge. However, edge-lit solutions have limited FOV due to the low angular carrying capacity of an edge-lit holographic substrate. Diffractive waveguides configured as combiners or projectors for reflecting light off a windshield offer compact form factors and provide one-dimensional or two-dimensional beam expansion for enabling large eye boxes eliminating the need for external pupil replication. However, current waveguide solutions have FOV limitations, and suffer from very low efficiency due to losses on coupling the image projector into the waveguide.

Holographic waveguides tend to be hazy due to beams undergoing multiple grating interactions along long waveguide paths.

Thus, there is a need for improved displays such as HUDs that offer high brightness, a wide FOV, and a large exit pupil.

### SUMMARY

It has been discerned that displays such as HUDs are able to provide high brightness, a wide FOV, and a large exit pupil. This discovery has been exploited to provide the present disclosure which, in part, provides displays and methods of their use.

In one aspect, the disclosure provides a display including: an optical substrate; a first display panel, for example a microLED display panel or any other suitable micro display panel; a second display panel, for example a microLED display panel or any other suitable micro display panel; a first metalens element configured to collimate and projected image light from the first display panel into a first optical path in the optical substrate; a second metalens element configured to collimate and project image light from the second display panel into a second optical path in the optical substrate; and a reflector, for example a reflection grating or reflection hologram, for directing image light from the optical substrate into an exit pupil.

MicroLED display panels and other micro display panels, such as micro OLED panels, offer scope for very compact, high brightness, high-resolution image source that can be manufactured at a price point low enough to allow more than one device to be used in a HUD.

Coupling wide-angle image information from a, for example microLED, image source into an optical substrate with high efficiency is a challenge in diffractive HUD design. Metalenses enable a compact solution to combining image light from multiple microLED source efficiently and cost effectively. Metalenses comprise metasurfaces, which are slabs of subwavelength thickness containing subwavelength in-plane features that are used to realize a predetermined functionality by local modification of the interaction between the slab and incident electromagnetic fields. Because metalenses operate at the nanometre-scale, a greater degree of phase and amplitude control can be achieved than can be achieved using conventional diffractive optical elements (DOEs). In contrast, cconventional DOEs operate at the micron scale with feature heights that are significant fractions of visible band wavelengths, resulting in more limited capacity for phase control, especially when manufacturing tolerances are factored in.

In certain examples the optical substrate includes a curved refractive element, a diffractive optical element, a holographic optical element, a metalens, and/or a curved reflective optical element.

In certain examples, the first display panel emits light of a first wavelength in a first FOV for viewing through a first portion of the exit pupil. The second display panel emits light at the first wavelength in the first FOV for viewing through a second portion, different from the first, of the exit pupil. In some examples, the first display panel emits light of a first wavelength in a first FOV for viewing through the exit pupil. The second display panel emits light at a second wavelength, different from the first, in the first FOV for viewing through the exit pupil. In some examples, the first display panel emits light of a first wavelength in a first FOV portion for viewing through the exit pupil, and the second display panel emits light at the first wavelength in a second FOV portion, different from the first, for viewing through the exit pupil.

In certain examples, the first and/or second metalens element provides a first beam expansion. In certain examples, the reflector provides a beam expansion in one direction. In some examples, the first and/or second metalens element provides a first beam expansion, and the reflector provides a second beam expansion orthogonal to the first beam expansion. In some examples, the first and second metalens elements abut, stack, are multiplexed, comprise common elements, comprise interspersed diffracting features, or form part of a two-dimensional array. In certain examples, at least one of the metalens elements: is configured as a conformal layer on a curved surface; is coated with a reflective material; is characterized by a prescription for diffracting infrared wavelengths; is integrated within a cast lens; is in optical contact with a liquid crystal layer; is backfilled with liquid crystal; is a Pancharatnam-Berry metalens; is a geometric phase metalens; and/or is a nanostructure including fins.

In some examples, at least one of the metalens elements is fabricated using a UV lithographic process, a deep UV lithographic process, and/or self-organization of a mixture comprising at least one monomer and at least one inert material.

In certain examples, the display is configured to provide a light field display.

In some examples, the reflector is selected from the group of nanostructure elements, an array of nano-structured elements, and a stack of elements each configured for a wavelength emitted by the display panels.

In some examples, the first and/or second metalens elements and the reflection grating or reflection grating are formed on a common surface. In certain examples, the first and/or second metalens elements are formed on a first substrate and the reflector is formed on a second substrate.

In some examples, the first and/or second metalens elements include a prescription such as for correcting aberrations, for diffracting infrared, and/or for polarization modification.

In some examples, the optical substrate is glass or plastic.

In certain examples, the display is configured as a monochrome display or a transparent display.

In some examples, the optical substrate is curved in at least one or two orthogonal planes, wherein the first display panel displaying an image predistorted for viewing through a first portion of the exit pupil, and the second displaying panel displays an image predistorted for viewing through a second portion of the exit pupil.

In some examples, the display comprises at least one dynamic lens. In certain examples, the dynamic lens includes a liquid crystal layer. In some examples, the dynamic lens is positioned between two optical substrates.

In some examples, at least one of the first display panel, the second display panels, the first metalens element, the second metalens element, and the reflection grating is embedded within a substrate formed using a casting process.

In some examples, the display is configured as a HUD.

In particular examples, the display further comprises an eye tracker.

In another aspect, the disclosure features a display that includes: an optical substrate; a first display panel, for example a microLED display panel or other suitable micro display panel; a second display panel, for example a microLED display panel or other suitable display panel; a first metalens element configured to collimate and project image light from the first display panel into a first optical path in the optical substrate during operation of the display; a second metalens element configured to collimate and project image light from the second display panel into a second optical path in the optical substrate during operation of the display; and a reflector, for example a reflection grating or reflection hologram, configured to direct image light from the substrate into an exit pupil of the display during operation of the display.

Implementations of the display can include one or more of the following features and/or features of other aspects. For example, the display can be a heads up display (HUD).

The display can be configured so that, during operation, the first display panel emits light of a first wavelength in a first field of view (FOV) for viewing through a first portion of the exit pupil, and the second display panel emits light at the first wavelength in the first FOV for viewing through a second portion of the exit pupil.

The display can be configured so that, during operation, the first display panel emits light of a first wavelength in a first FOV for viewing through the exit pupil, and the second display panel emits light at a second wavelength in the first FOV for viewing through the exit pupil.

The display can be configured so that, during operation, the first display panel emits light of a first wavelength in a first FOV portion for viewing through the exit pupil, and the second display panel emits light at the first wavelength in a second FOV portion for viewing through the exit pupil.

The first metalens element can be configured to provide a first beam expansion.

The reflector can be configured to provide a beam expansion in one direction.

The first metalens element can be configured to provide a first beam expansion, and the reflector is configured to provide a second beam expansion orthogonal to the first beam expansion.

The first and second metalens elements can abut one another, are stacked relative to one another, are multiplexed, comprise interspersed diffracting features, and/or form part of a two-dimensional array.

At least one of the first and second metalens elements can be configured as a conformal layer on a curved surface, coated with a reflective material, characterized by a prescription for diffracting infrared wavelengths, integrated within a cast lens, in optical contact with a liquid crystal layer, backfilled with liquid crystal, a Pancharatnam-Berry metalens, a geometric phase metalens, and/or a nanostructure comprising fins.

At least one of the first and second metalens elements can be fabricated by a UV lithographic process, a deep UV lithographic process, and self-organization of a mixture of at least one monomer and at least one inert material.

In some examples, the display is a light field display.

The reflection grating can include a nanostructure element, an array of nanostructured elements, and/or a stack of elements, each element configured for a different wavelength emitted by the microLEDs.

At least one of the first and second metalens elements and the reflector can be formed on a common surface.

The first and/or second metalens elements can be formed on a first substrate, and the reflector is formed on a second substrate different from the first substrate.

The first and/or second metalens elements can be configured according to prescriptions selected from the group consisting of correcting aberrations, diffracting infrared light, and modifying polarization.

The optical substrate can include a glass substrate or a plastic substrate.

The display can include a monochrome display. The display can include a transparent display. The display can include an eye tracker.

The optical substrate can be curved in at least one plane, wherein, during operation, the first display panel is configured to display a first image predistorted for viewing through a first portion of the exit pupil, and the second display panel is configured to display a second image predistorted for viewing through a second portion of the exit pupil.

The display can include at least one dynamic lens. The dynamic lens can include a liquid crystal layer. The display can include first and second optical elements each arranged on opposing sides of the dynamic lens, the first and/or second optical elements being selected from the group consisting of a curved refractive element, a diffractive optical element, a holographic optical element, a metalens, and a curved reflective optical element.

At least one of the first display panel, the second display panel, the first metalens element, the second metalens element, and the reflector, can be embedded within a substrate formed using a casting process.

During operation, the first display panel and the second display panel can be activated simultaneously and display identical data.

The display can include a layer of an opaque material defining a first aperture and a second aperture, the layer of the opaque material being arranged between the first and second display panels and the optical substrate, where a center of the first aperture lies on a center beam axis of the first display panel and a center of the second aperture lies on a center beam axis of the second display panel, where the first aperture and the second aperture are configured to prevent a beam from the first display panel from overlapping with the beam from the second display panel during operation of the display.

In some examples, the display includes a prism disposed between the microLEDs and the metalenses. In some examples, the first and second metalens elements are part of a metalens array of metalens elements. In some examples, the metalens array comprises abutting metalens elements, and/or overlapping metalens elements, and/or multiplexed metalens elements.

In another aspect, the disclosure comprises a display comprising: An optical substrate; a first display panel, for example a microLED display panel or other suitable micro display panel; a second display panel, for example a microLED display panel or other suitable micro display panel; a first lens group configured to collimate and project image light from the first display panel into a first optical path in the optical substrate during operation of the display; a second lens group configured to collimate and project image light from the second display panel into a second optical path in the optical substrate during operation of the display; and a reflector, for example a reflection grating or reflection hologram, configured to direct image light from the substrate into an exit pupil during operation of the display.

Implementations of the display comprises one or more of the following features and/or features of other aspects. In one example, the first lens group includes a gradient index (GRIN) lens element, and/or the second lens group can include a GRIN lens element.

In some examples, the first lens group includes at least one refractive element, and the second lens group further comprises at least one refractive element.

In certain examples, the first lens group includes at least one freeform refractive surface, and the second lens group further can include at least one freeform refractive surface.

In some examples, the first lens group includes at least one diffractive optical element, and the second lens group comprises a GRIN lens and at least one diffractive optical element. In particular examples, the first lens group includes at least one metalens element, and/or the second lens group further can include at least one metalens element.

The details of one or more embodiments are set forth in the accompanying drawings and the description below. Other features and advantages will be apparent from the description and drawings, and from the claims.

### BRIEF DESCRIPTION OF THE DRAWINGS

The foregoing and other objects of the present disclosure, the various features thereof, as well as the disclosure itself may be more fully understood from the following description, when read together with the accompanying drawings in which:

FIG. 1A is a diagrammatic representation illustrating in a cross-section view of a HUD assembly providing exit pupil tiling, in accordance with the disclosure;

FIG. 1B is a diagrammatic representation illustrating in a front elevation view of a HUD assembly providing exit pupil tiling, in accordance with the disclosure;

FIG. 1C is a diagrammatic representation illustrating in a cross-sectional view of a HUD assembly providing exit pupil tiling, in accordance with the disclosure;

FIG. 2A is a diagrammatic representation illustrating in a cross-section view of a HUD assembly providing field-of-view tiling, in accordance with the disclosure;

FIG. 2B is a diagrammatic representation illustrating in a front elevation view of a HUD assembly providing e field of view tiling, in accordance with the disclosure;

FIG. 2C is a diagrammatic representation illustrating in a cross-section view of a HUD assembly providing field of view tiling, in accordance with the disclosure;

FIG. 3 is a diagrammatic representation illustrating in a cross-section view of a metalens array formed from abutting elements, in accordance with the disclosure;

FIG. 4 is a diagrammatic representation illustrating in a cross-sectional view of a metalens array formed from stacked and abutting elements, in accordance with the disclosure;

FIG. 5 is a diagrammatic representation illustrating in a cross-sectional view of a metalens array formed from multiplexed elements, in accordance with the disclosure;

FIG. 6 is a diagrammatic representation illustrating in a side-elevation view of a HUD assembly including stacked reflection gratings operating in different wavelength bands, in accordance with the disclosure;

FIG. 7A is a diagrammatic representation illustrating in a cross-sectional view of a HUD assembly including a metalens array with elements for imaging different wavelength bands arranged in different rows, in accordance with the disclosure;

FIG. 7B is a diagrammatic representation illustrating in a front elevation view of a HUD assembly including a metalens array with elements for imaging different wavelength bands arranged in different rows, in accordance with the disclosure;

FIG. 8 is a diagrammatic representation illustrating an exemplary apparatus for combining image light from red, green, and blue emitting microLED panels using a dichroics beamsplitter cube, in accordance with the disclosure;

FIG. 9 is a diagrammatic representation illustrating in a cross-sectional view of a metalens array formed from overlapping metalens elements where diffracting features from each element interspersed within the overlapping regions, in accordance with the disclosure;

FIG. 10A is a diagrammatic representation illustrating in a front elevation view of a metalens array configured such that portions of adjacent lens elements include the elements of a repeating pattern, in accordance with the disclosure;

FIG. 10B is a diagrammatic representation illustrating in a cross-sectional view of a metalens array configured such that portions of adjacent lens elements include the elements of a repeating pattern, in accordance with the disclosure;

FIG. 11 is a diagrammatic representation illustrating in a side-elevation view of a HUD assembly including a reflection grating configure as an array of diffractive elements, in accordance with the disclosure;

FIG. 12A is a diagrammatic representation illustrating in a cross-sectional view of a light field display employing a two-dimensional array of metalenses, in accordance with the disclosure;

FIG. 12B is a diagrammatic representation illustrating in a front elevation view of a two-dimensional array of metalenses, in accordance with the disclosure;

FIG. 13 is a diagrammatic representation illustrating in a side elevation view of an optical assembly including a metalens and an optical element with a freeform optical surface, in accordance with the disclosure;

FIG. 14 is a diagrammatic representation illustrating in a side elevation view of an optical assembly including a metalens conformed to the freeform optical surface of freeform optical element, in accordance with the disclosure;

FIG. 15 is a diagrammatic representation illustrating a HUD encapsulated within a curved surface optical element formed from molds providing a cavity for the HUD, in accordance with the disclosure;

FIG. 16 is a diagrammatic representation illustrating a HUD encapsulated within a planar surface optical element formed from molds providing a cavity for the HUD, in accordance with the disclosure;

FIG. 17 is a diagrammatic representation illustrating a side view of a curved visor combiner display, in accordance with the disclosure;

FIG. 18 is a diagrammatic representation illustrating a plan view of horizontal regions of the substrate providing imagery viewed at multiple pupil positions, in accordance with the disclosure;

FIG. 19A is a diagrammatic representation illustrating a front elevation view of the microLED array and metalens array showing metalens elements, in accordance with the disclosure;

FIG. 19B is a diagrammatic representation illustrating an unfolded view showing the optical paths from the microLED panels through the metalens elements to the eye pupils, via the substrate, in accordance with the disclosure;

FIG. 19C is a diagrammatic representation illustrating a front view of the visor substrate, in accordance with the disclosure;

FIG. 20 is a flow designation of an exemplary method for displaying an image using a holographic visor combiner including microLEDs and metalenses, in accordance with the disclosure;

FIG. 21 is a diagrammatic representation illustrating a cross-sectional view of a dynamic lens including a first refractive lens and a second refractive lens arranged on opposing sides of a liquid crystal lens layer, in accordance with the disclosure;

FIG. 22 is a diagrammatic representation illustrating a dynamic lens provided by a metalens and a refractive lens arranged on opposing sides of a liquid crystal lens layer, in accordance with the disclosure;

FIG. 23 is a diagrammatic representation conceptually illustrating in front elevation view of a configuration of an optical assembly including microLED array elements, a metalens array and a dynamic lens array, in accordance with the disclosure;

FIG. 24 is a diagrammatic representation illustrating ray paths through the dynamic lens array and the multiplexed metalens array in a plan view of the components of FIG. 23, in accordance with the disclosure;

FIG. 25A is a diagrammatic representation illustrating in-side elevation view of a visor incorporating an eye tracker, in accordance with the disclosure;

FIG. 25B is a diagrammatic representation illustrating in front elevation view of a visor incorporating an eye tracker, in accordance with the disclosure;

FIG. 26 is a diagrammatic representation illustrating in cross-section of a visor formed from upper and lower encapsulation substrates arranged on opposing sides of a reflection hologram layer according to the disclosure;

FIG. 27 is a diagrammatic representation illustrating a microLED substation in cross-section that may improve light collection efficiency, in accordance with the disclosure;

FIG. 28 is a diagrammatic representation illustrating in cross-section of a visor using prismatic input coupling optics, in accordance with the disclosure;

FIG. 29A is a diagrammatic representation illustrating a cylindrical visor, showing the viewing region and surrounding substrate in a side cross section view and showing the viewing region and surrounding substrate in a plan cross-section view, in accordance with the disclosure;

FIG. 29B is a diagrammatic representation illustrating a visor formed from two principal curves showing the viewing region and surrounding substrate both having a first curvature in a side cross-section view, and showing the viewing region and surrounding substrate, both having a second curvature in a plan cross section view, in accordance with the disclosure;

FIG. 29C is a diagrammatic representation illustrating conceptually illustrates a visor providing a cylindrical viewing region with the surrounding regions have two different curvatures, showing the viewing region and surrounding substrate and showing the viewing region and surrounding substrate, in accordance with the disclosure;

FIG. 29D is a diagrammatic representation illustrating conceptually illustrates a visor providing a flat viewing region with the surrounding regions having cylindrical geometry, showing the viewing region and surrounding substrate, and showing the viewing region and surrounding substrate, in accordance with the disclosure;

FIG. 29E is a diagrammatic representation illustrating a visor providing a viewing region with a shallow curvature with the surrounding regions having cylindrical geometry showing the viewing region and surrounding substrate, and showing the viewing region and surrounding substrate, in accordance with the disclosure;

FIG. 30A is a diagrammatic representation illustrating in side-elevation view of a visor incorporating a GRIN lens element array, in accordance with the disclosure;

FIG. 30B is a diagrammatic representation illustrating a microLED substation in cross-section that improves light collection efficiency, in accordance with the disclosure;

FIG. 30C is a diagrammatic representation illustrating in front elevation view of a visor incorporating a GRIN lens element array, in accordance with the disclosure;

FIG. 31A is a diagrammatic representation illustrating in-side elevation view of a visor incorporating a GRIN lens element array, in accordance with the disclosure;

FIG. 31B is a diagrammatic representation illustrating a microLED substation in cross section that may improve light collection efficiency, in accordance with the disclosure;

FIG. 31C is a diagrammatic representation illustrating in front elevation view of a visor incorporating a GRIN lens element array, in accordance with the disclosure;

FIG. 32A is a diagrammatic representation illustrating in-side elevation view of a visor incorporating a GRIN lens element array, in accordance with the disclosure;

FIG. 32B is a diagrammatic representation illustrating a microLED substation in cross-section that may improve light collection efficiency, in accordance with the disclosure;

FIG. 32C is a diagrammatic representation illustrating in front elevation view of a visor incorporating a GRIN lens element array, in accordance with the disclosure; and

FIG. 32D is a diagrammatic representation illustrating a front elevation view of an aperture array for use in a visor, in accordance with the disclosure.

### DESCRIPTION

The disclosures of these patents, patent applications, and publications in their entireties are hereby incorporated by reference into this application in order to more fully describe the state of the art as known to those skilled therein as of the date of the disclosure described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group, unless otherwise indicated. Parts of the following description will be presented using terminology commonly employed by those skilled in the art of optical design.

As used herein, the articles “a” and “an” refer to one or to more than one (i.e., to at least one) of the grammatical object of the article. By way of example, “an element” means one element or more than one element. Furthermore, use of the term “including” as well as other forms, such as “include,” “includes,” and “included,” is not limiting.

As used herein, the term “about” will be understood by persons of ordinary skill in the art and will vary to some extent on the context in which it is used. As used herein when referring to a measurable value such as an amount, a temporal duration, and the like, the term “about” is meant to encompass variations of ±20% or ±10%, including±5%, ±1%, and ±0.1% from the specified value, as such variations are appropriate to perform the disclosed methods.

The terms “light” and “illumination” may be used in relation to the visible and infrared bands of the electromagnetic spectrum.

The terms “light”, “ray”, and “beam” may be used interchangeably and in association with each other to indicate the direction of propagation of electromagnetic radiation along rectilinear trajectories.

As used herein, the term “grating” may encompass a grating that includes a set of gratings in some examples.

In this specification the terms “metalens” and “metasurface” are used. A metasurface is a two-dimensional surface patterned with structures that have a smallest dimension that is subwavelength for a given application and exhibit a desired optical behavior. For example, for visible light applications, the structures are nanostructures having a smallest dimension of less than 10′m. A metalens is a metasurface or other metastructure configured to perform a lensing function, that is to emulate a refractive lens when light is incident on the metalens, for example to focus the incident light.

For simplicity and clarity of illustration, reference numerals may be repeated among the figures to indicate corresponding or analogous elements. Numerous details are set forth to provide an understanding of the embodiments described herein. The examples may be practiced without these details. For the purposes of explaining the disclosure, well-known features of optical technology known to those skilled in the art of optical design and visual displays have been omitted or simplified in order not to obscure the basic principles of the disclosure.

Reference is made herein to microLED and microLED display panels (or panels for short). It will be appreciated that this is an example display technology and that other display technologies are in used in various embodiments. In the described examples, therefore, microLED and microLED (display) panels may be replaced throughout with any other suitable display panel or micro display panel, for example a microOLED display panel. Likewise, reference is made to reflection gratings and reflection holograms as reflectors. It will be appreciated that these are example reflector technologies and that other reflectors are used in various embodiments. Therefore, in the described examples, reflection gratings or reflection holograms may be replaced with any other suitable reflectors. Reference is further made to a metalens array comprising metalens elements. It will be understood that this refers to an array of metalenses, that is an array having metalenses as elements. The terms metalens and metalens element are thus used interchangeably. The present disclosure is directed to devices which display information.

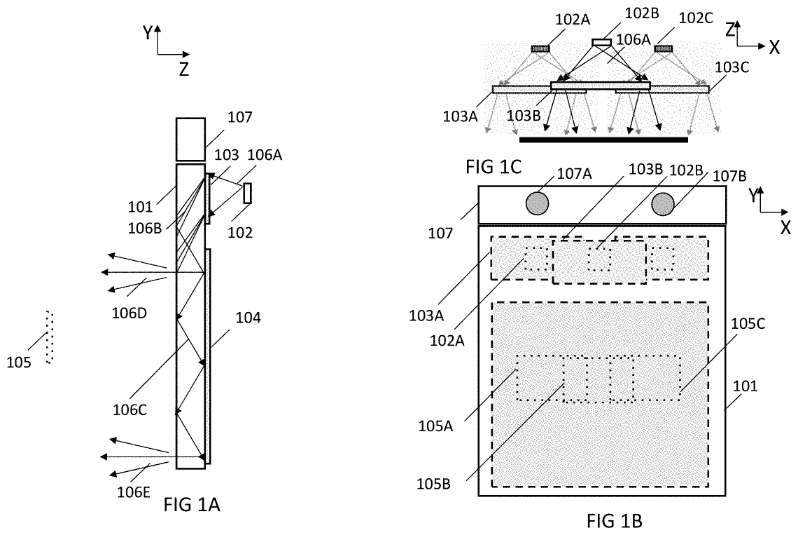

FIGS. 1A-1C conceptually illustrates one non-limiting example of such a display which in this figure is a monochrome HUD. Such a device comprises: an optical substrate; a first display panel; a second display panel; a first metalens element configured to collimate and project image light from the first display panel into a first optical path in the optical substrate during operation of the display; a second metalens element configured to collimate and project image light from the second display panel into a second optical path in the optical substrate during operation of the display; and a reflector and configured to direct image light from the substrate into an exit pupil of the display during operation of the display.

Non-limiting examples of such displays include, but are not limited to an HUD, a light field display. The HUD may include three microLED panels (102A-102C), and an optical substrate (101) supporting a metalens array (103) and a reflection grating (104). The metalens array includes a plurality of metalens elements (103A-103C) each of which is optically coupled to a microLED panel. The optical substrate provides optical paths from the metalens array to the reflection grating. The optical paths may include total internal reflection at least one substrate surface. In other examples, more or fewer microLED panels and associated metalens elements may be used.

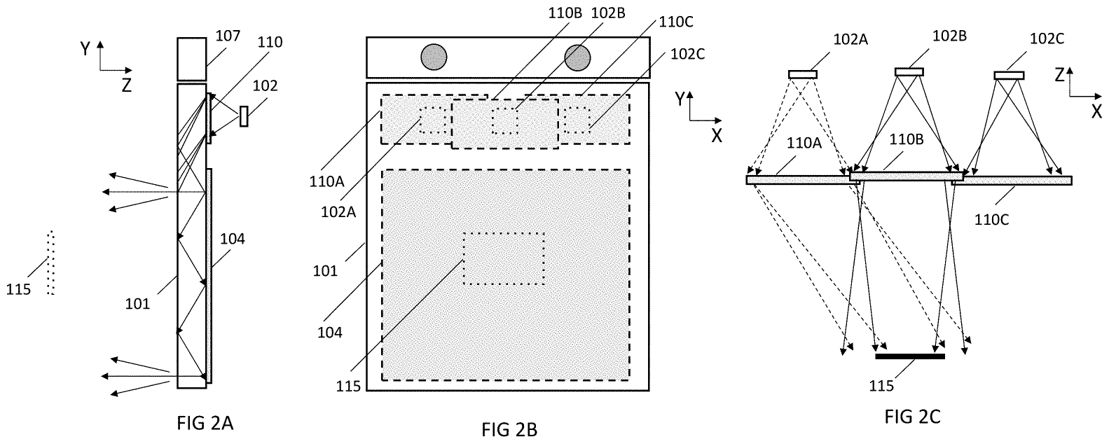

Each metalens element (103A-103C) is a metalens configured to collimate and project light from each microLED panel along a substrate optical path towards an exit pupil (105), (which may also be referred to as an “eye box”) the light path being generally represented by rays 106A-106E. Each microLED panel displays information to be projected in a FOV viewable from the eye box with each panel providing light for viewing through a portion of the pupil. In the case of the three-panel architecture illustrated, the pupil is split into three pupil regions (105A-105C), essentially providing pupil tiling. In some examples where an acceptable pupil can be provided without tiling, the metalenses are configured to project different portions of the FOV to provide abutting FOV portions viewable from the exit pupil, essentially providing FOV tiling, as conceptually illustrated in FIGS. 2A-2C. In the case of FOV tiling each microLED panel displays a portion of the FOV. The light from each panel is directed into a common exit pupil (115) using an array (110) of metalenses (110A-110C) as metalens elements. In some examples, the microLEDs and metalens elements are configured to provide more than one FOV tile and more than one exit pupil tile.

In some examples, the metalens array and the reflection grating are formed on a common substrate surface. In some examples, the metalens array and the reflection grating are disposed on opposing faces of the optical substrate. In some examples, the metalens array and the reflection grating are formed on different substrates which may be edge connected.

In some examples, the display further comprises an eye tracker for detecting gaze direction and eye location to enable eye-slave tiling of pupils or FOV portions. In one non-limiting example, an eye tracker (107) is implemented using infrared source (107A) and image sensor (107B) mounted around the periphery of the display, as conceptually illustrated in FIG. 1A and FIG. 1B, with the output from, the image sensor which may be connected to a processor containing an eye tracking algorithm. In some examples, at least one of the illuminations and detection optical paths are provided using one or more light guiding substrates overlaying at least a portion of the HUD. In some examples the eye tracker illumination and detection functions are implemented as nanostructures within the metalens array. In some examples the metalens array has a broadband response allow diffraction of near infrared radiation for eye tracking. In some examples, the eye tracker is provided by at least one camera and at least one light source disposed around the periphery of the display. For examples, the eye tracker employs a light guiding structure for conveying light scattered or reflected from surfaces of the eye to a detector and conveying light from an illumination source toward an eye surface. The eye tracker employs a source and detector operating at near infrared wavelengths. In some examples, infrared wavelengths about 1550 nm are used to comply with optical eye safety standards.

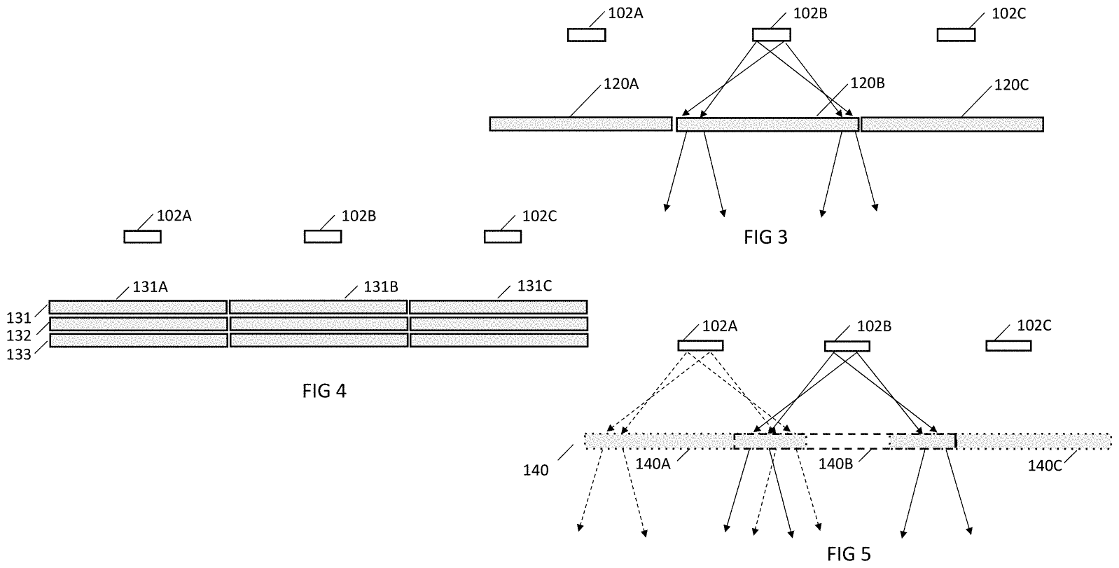

The metalens array may include an array of abutting lenses formed in a single layer each lens overlapping a microLED with its features symmetrically disposed about the center of the microLED. In some examples, lens prescriptions include on-axis and off-axis configurations of the microLED with respect to the lens. In some examples, a metalens array includes abutting elements as conceptually illustrated in FIG. 3, which shows an example including abutting elements (120A-120C). In some examples, a metalens array includes stacked elements as conceptually illustrated in FIG. 4, which shows an example that includes a stack of metalens layers (131-133) with each layer containing abutting metalens elements (131A-131C). In some examples a metalens arrays are configured as a two-dimensional array. In some examples, a metalens array includes multiplexed elements as conceptually illustrated in FIG. 5, which shows a metalens layer (140) multiplexing the metalens elements (140A-140C).

The microLED panels may emit light at the same wavelength. In some examples the display provides monochromatic imagery. In some examples the display provides green imagery. For example, a green (520 nm-530 nm) microLED panel (such as manufactured by Jade Bird Display (CN) with product number JBD5UM720P-G) can provide up to 3.5×10⁶ nits luminance, 1280×720 pixel resolution, at a 5-micron pixel pitch and 6.72 mm.×3.92 mm. active area, with 256 levels and 240 Hz update rate. Yet another exemplary device (product number JBD25UMFHDG) manufactured by the same company provides 1.5×10⁶ nits luminance, 1920×1080 pixel resolution, 2.5-micron pixel pitch 4.8 mm.×2.7 mm. active area 256 levels, and 240 Hz update rate. Another exemplary device (product number J013G01VGA) manufactured by the same company provides 3.5×10⁶ nits luminance, 640×480 pixel resolution, 4-micron pixel pitch 2.64 mm.×2.02 mm. active area 16 gray levels, and an update rate of 50 Hz.

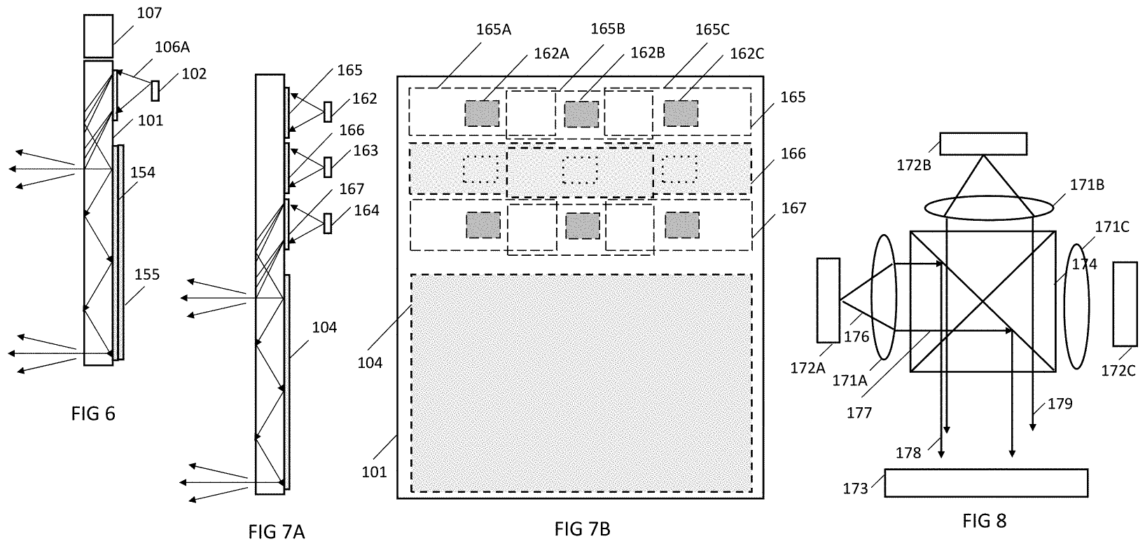

In some examples the display includes microLEDs emitting in different primary wavelength bands, such as red, green, and blue, to provide color imagery. In any such examples, the metalens array includes lens elements separately optimized to diffract one of the colors. In some examples the metalens array include metalens elements with prescriptions for diffracting more than one wavelength band. In some examples, a broadband metalens diffracts light across the visible band. In color display applications, the reflection grating includes a stack of refection gratings, as conceptually illustrated in FIG. 6, which shows an example with two stacked reflection grating layers (154-155) with prescriptions for diffracting different wavelength bands emitted by microLED panels. In some examples directed at color HUDs, the red, blue, and green, microLEDs and metalenses are arranged as depicted in FIGS. 7A-7B, which show an example including the microLED rows 162-164 each including microLEDs (162A-162C). Light from each microLED is collimated and projected using one of the metalenses provided in the rows (165-167) of metalens elements (165A-165C).

In some examples directed at color displays, the light emitted by red, green, and blue microLEDs are combined using a dichroic cube beam combiner using a configuration similar to the one conceptually illustrated in FIG. 8. In this example, the microLEDs (172A-172C) are collimated using condenser lenses (171A-171C) and combined using a dichroic beam combiner (174), the combined beams being directed towards a metalens element (173). Exemplary beam paths are indicated by the rays 176-179. Other equivalent optical assemblies for combing image light from more than one image source may also be used.

In some examples the R-HOE provides a one-dimensional beam expansion and extraction from multiple total internal reflections. In some examples, the display provides beam expansion in two orthogonal directions with the metalens performing the functions of light collection, beam collimator and first direction expander and the reflection HOE providing a second direction expansion where the first and second directions are orthogonal. In some examples such as one conceptually illustrated in FIG. 9, a metalens array is formed from overlapping metalens elements where diffracting features from each element are interspersed within the overlapping regions. FIG. 9 conceptually illustrates an example with metalens elements (183A-183C) of a metalens array, each having a prescription corresponding to an exit pupil or FOV tile. Element (184A, 184B) from metalens elements 183A, 183B may be interspersed and elements (185A, 185B) from metalens elements 183B, 183C may be interspersed.

The various disclosed examples employ a wide range of metalens configurations for the metalens elements. In some examples, metalenses are based on gradient metasurfaces. In gradient metasurfaces, the reflection and transmission at the interface between the incident medium and the metasurface are characterized by the gradient of a space dependent phase that is imprinted onto the incident wavefronts by the metasurface. Gradient metasurfaces exhibit spatially scattered fields that may have spatial variations of at least one of amplitude, phase, and polarization. Gradient index metalens may take several forms including electrical dipole, geometric, reflective and Huygens' metasurfaces. In some examples, the phase variations are provided in a piecewise fashion using an array of metalens elements. In some examples, the phase variations are a linear function of distance along the metasurface where the phase is of the form±2π×/Λ, where Λ is the distance along the metasurface within which a phase change of a occurs. In some examples, the phase variation has a piecewise, rather than a continuous, spatial profile. In some examples, the phase variation is determined by the properties of multiple metalens elements.

In some examples, a gradient metalens includes a subwavelength periodic array of dielectric or metallic inclusions for providing a pure electric dipole (ED) response. In many such examples, the metasurface may have an isotropic response.

Metalenses may be based on a Huygens type of gradient metasurface including diffractive features that provide a thin layer of orthogonal electric and magnetic dipoles, which form an array of Huygens' sources. In a typical metalens configuration, these sources may radiate mostly in the forward direction and may be used to manipulate an incident electromagnetic wave. In the case of a passive Huygens gradient metalens, the Huygens' sources may be induced by the incident electromagnetic field.

Geometric phase metasurfaces include arrays of nanofins, whose orientation determines the phase shift imparted to the light. Geometric metasurfaces may provide very high optical efficiencies, which may approach 100%. In some examples, a gradient metalens based on the geometric phase employs Pancharatnam-Berry phase nanostructures. Pancharatnam-Berry phase optical elements provide constant retardation (e.g., essentially a half wave plate) with spatially varying optical axis directions. This enables continuous optical phase shifts without phase discontinuities at boundaries, leading to high-efficiency diffraction. Pancharatnam-Berry metalens use circularly polarized incident light. In some examples, two layers of Pancharatnam-Berry optical elements (typically, but not limited to, nanofin arrays) are superimposed. In some examples, incident circularly polarized light is split into different helicities for focusing at different foci with controlled intensity and focal length. In some examples, decoupling the focusing length and the relative intensity enables an arbitrary combination of focal spot location and relative intensity. In some examples, the functionalities of Pancharatnam—Berry optical elements are applied systems including more than two layers. Multilayer Pancharatnam-Berry optical systems may be applied to achromatic metalenses. In some examples, multilayer Pancharatnam-Berry optical systems are used to provide field of view tiling as discussed above. In some examples, multilayer Pancharatnam-Berry optical systems are used to provide exit pupil tiling as discussed above.

In many display configurations, the metalens array is not transparent. For example, metalenses based on titanium oxide nanofins fins formed on a glass substrate may be used to achieve diffraction limited resolution. Such structures may have diffractive features several hundreds of nanometers in height with widths as small as tens of nm in at least one other dimension. In some examples, the diffractive features of a metalens array may be in the range of 200 to 700 nm high.

In specific examples, a reflective gradient metalens is provided by placing a metasurface near an optically thick metal film, hereby ensuring that transmission is zero. This type of metasurface is not only limited to controlling circular polarization states, but may also fully control reflected light of linear polarization.

In specific examples, metalenses are configured as truncated waveguide metasurfaces including arrays of nanorods whose diameters determine the effective refractive index of the optical mode propagating through them, thus allowing phase control.

In contrast to conventional DOEs, which typically may use multilevel processing, a metalens can be formed using a single lithographic mask which integrate multiple optical components within a common phase profile on a single surface. For example, deep UV lithography can be used for form nanostructures for operation visible and near infrared wavelength bands. In some examples deep UV lithography is carried out using UV radiation provided using a carbon dioxide laser and a tin (Sn) plasma. Deep UV lithography may be used to form nanostructures, e.g., by self-organization in mixtures of polymerizable monomers and inert materials. Such polymer-based nanostructures formed on glass or polymer substrates offer a low cost transparent metalens solution in a variety of applications. In some examples, the inert material is a liquid crystal and/or includes nanoparticles.

The metalens may integrate optical and electronic functions, e.g., sensors and imaging systems on a common substrate using a common manufacturing process using nanostructures. For example, the metalens is configured to include nanostructures for providing micro electronic devices such as, but not limited to, light sensors, micro cameras, LEDs, microphones, etc. In some examples, infrared devices including, but not limited to, IR LEDs and micro cameras, are incorporated within the HUD for eye tracking. In some examples, such devices are powered by conventional, solar, or other batteries connected via conductive printed circuits. In some examples, electronic circuitry for control and communications is incorporated using nanowire technology-based, lithographically-fabricated, transparent conductors. Nanowires may include thin wires formed into a conformable, invisible to the naked eye, mesh pattern, and may have wire diameter of approximately 500 nm, conductivity in the range 1-10 Ω/sq, and optical transparency in the range 95%-99%. Unfortunately, existing transparent conductive materials (ITO, Ag Nanowires etc.), have poor mechanical stability, low optical transmissivity, and low electrical conductivity. As such, ITO is not suitable for wrapping around lens as the thickness may make it brittle. However, an exemplary nanowire technology which achieves the above performance characteristics is NANOWEB® (Meta Materials Inc.). Nanowire structures suitable for use in displays such as, but not limited to, may be manufactured using a lithographic process. Such examples, nanowire structures may be manufactured using the Rolling Mask Lithography (RML®) process (by Meta Materials Inc.).

In some examples, a nanowire film provides a display such as, but not limited to a HUD cover transparent to both LIDAR and RADAR. In examples, the film is structured to be completely transparent and polarization-selective in relation to outgoing LIDAR and incoming RADAR, in an analogous way to glare reduction films used in displays. In contrast, Conventional ITO-based films would block the RADAR waves completely. In contrast to the disclosure is useful, e.g., in an Advanced Driving Support System (ADAS) technology for Autonomous Driving.

The HUD may further include an antifogging layer for heating the substrate so that there is no temperature gradient between the substrate and the surrounding air, eliminating moisture condensation on the substrate. The heat may be applied using a nanowire layer such as described above. Defogging performance depends on the amount of heat that deposited. Nanowire acts as a transparent conductor, and can thus carry electricity, which converts into heat on the lens via Ohm's Law. Nanowire films useful for this purpose are those developed by Meta Materials Inc. which can carry high heat density, in excess of 10,000 W/m², enabling fast defogging while maintaining high transparency compared to conventional films.

In some examples, the metalens includes an incorporated layer of liquid crystal. In some examples, liquid crystal, which may be backfilled into the nanostructure of the metalens for the purposes of modifying the refractive index modulation. In some examples, heat is applied to the metalens to stabilize the liquid crystal. to compensate for changes to the refractive index or birefringence of the liquid crystal for example, due to the heating effects of intense solar radiation. In some examples, the liquid crystal is used to provide metalens nanostructures switchable between a diffracting state and a non-diffracting state using the voltage dependent birefringence of the liquid crystal. The metalens may incorporate liquid crystal such that it can be electrically switched between different wavelength, angular range, or polarization states. In some examples the display includes a circular polarizer disposed between each microLED and metalens. Alternatively, other polarization components are used to control stray light and enhance image contrast. In some examples, various optical filters, such as, but not limited to, bandpass or edge filters, are used limit the effect of sunlight on image contrast, glare, and the general visibility of the displayed information. In some examples, a louver filter is used to block sunlight.

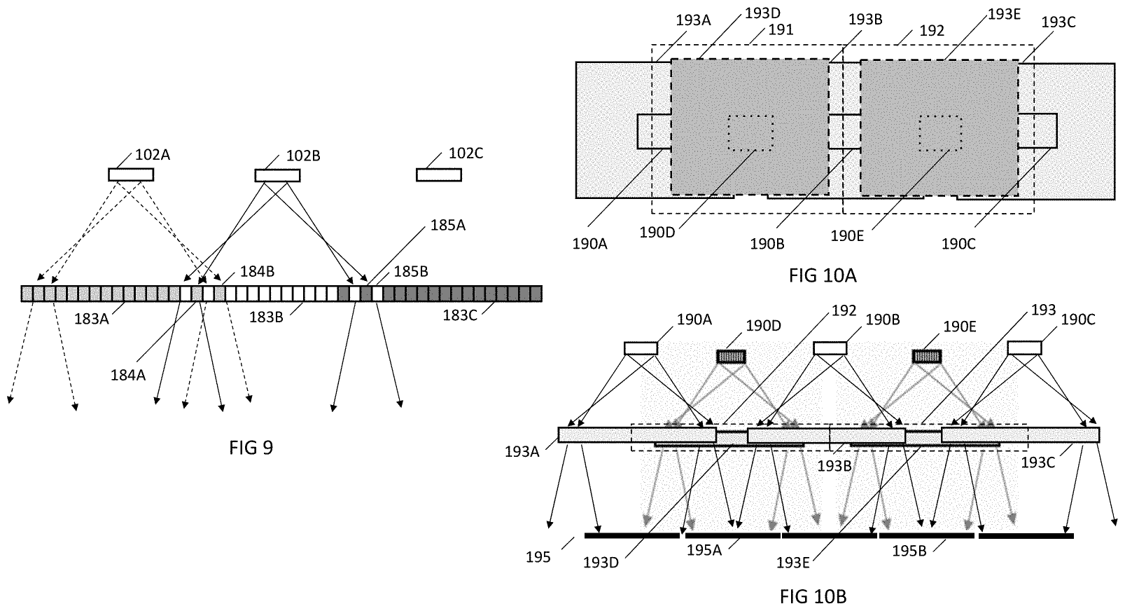

Display applications such as, but not limited to, HUD applications of metalenses may entail large area, high numerical aperture metalenses with optical efficiencies better than 90%. Broadband operations are also useful. However, the extensive computational resources that are used to implement the topological optimization used to achieve a high efficiency can limit metalens small dimension to a few millimeters. One non-limiting useful approach to optimizing large area metasurfaces in a computationally efficient manner is to stitch together individually optimized sections of the metasurface. This reduces the computational complexity of the optimization from high order polynomial to linear. The data density used to encode a metalens can be reduced by about three orders of magnitude for lenses of several centimeters in aperture, while retaining high efficiencies (>90%) by using scalable metasurface compression algorithms to reduce design file sizes and stepper photolithographic technology developed for semiconductor manufacturing. (See She et al. (2018) Optics Express, 26(2):1573-1585, herein incorporated by reference). A non-limiting example of a metalens array structure configured such that portions of adjacent metalens elements provide the elements of a repeating pattern suitable for piecewise fabrication in some examples is conceptually illustrated in FIGS. 10A-10B. The metalens array includes metalens elements (193A-193E) for projecting light from an array of microLEDs (190A-190E) to provide the array of exit pupils (195) containing exit pupil portions (195A, 195B). Two repeating metalens configurations (191, 192) are indicated.

The reflection grating may be a reflection HOE or a reflective surface relief grating. In some examples, a volume hologram is used to provide the refection grating. Alternatively, a reflection grating is provided by a reflective metalens. In some examples, a metalens mirror is provided by applying a reflective coating to a surface of the metalens. The reflective metalens may be a two-dimensional array of elements. In some examples the reflective metalens element has identical prescriptions. In some examples the metalens is configured to correct the aberrations of the reflection grating.

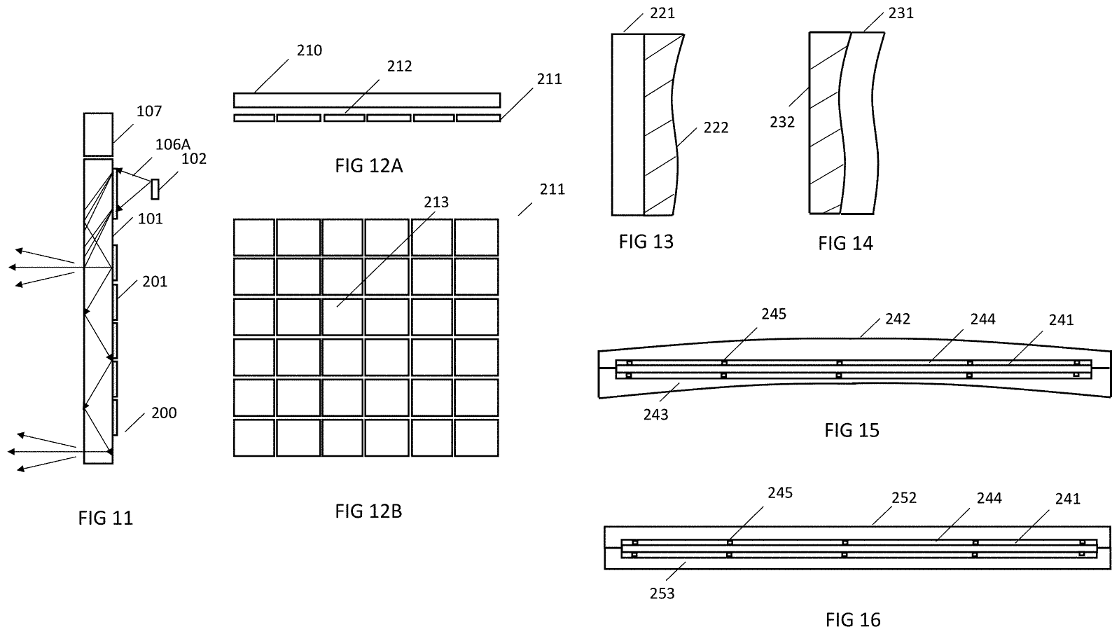

FIG. 11 conceptually illustrates an exemplary, non-limiting reflection grating configured as an array (200) of nano-structured elements (201) in accordance with some examples.

In many other examples, a metalens array is configured as a two-dimensional array of metalens elements for providing a light field displays (see FIGS. 12A-12B, which shows a microLED array (210) and an array (211) of metalens elements (212)). Alternatively, light field display projects information as a real image formed in front of the display. Alternatively, a light field display projects information as a virtual image formed behind the HUD.

In some examples, a metalens element overlays a microLED display such that the metalens structures are aligned to individual pixels of the microLED array to increase the light outcoupling efficiency of the pixel array. In some examples, the metalens is configured to provide a numerical aperture that varies across the pixel array. A spatially varying numerical aperture enables greater brightness uniformity in a display image.

In some examples, a metalens 221 forms a doublet (two complementary optical lenses) with an optical element (222) having at least one freeform surface as illustrated in the side elevation view of FIG. 13. A metalens (231) may be conformed onto an optical element (232) with a freeform surface, as illustrated in the side elevation view of FIG. 14. In some examples, a metalens and the freeform surface element structure further include a mirror coating.

The reflection grating may be formed as a foil or on a substrate that is encapsulated within a curved or planar optical element using a casting process. In some examples the metalens and the reflection grating are formed on a common substrate and encapsulated. Using a casting process, an optical element containing a cavity for accommodate a HUD, is formed by a mold having front and backside mold portions with curvatures matching the optical prescription of the optical element to be molded. In some examples, the optical component is a parallel face substrate. In some examples, the optical component includes at least one curved surface. The mold is filled with a curable monomer (e.g., but not limited to, a UV curable monomer, such as, but not limited to, a UV curable acrylic monomer) which forms a transparent polymeric lens. A pre-formed optic, which may be a holographic film or some other type of optical component, is inserted into the cavity. Curing of the monomer results in the optical foil being embedded within the optical element. After UV curing, the front and backside molds are removed and cleaned for re-use in the next casting cycle. In some examples curing takes place quickly, e.g., within seconds, at relatively low temperatures, e.g., less than about 100° C., making the process safe for holographic films that are used to provide the reflection grating. An exemplary, non-limiting casting process is the ARfusion™ process (Meta Materials, Inc.) for integrating application specific functional films into AR prescription lenses.

FIG. 15 conceptually illustrates a HUD (241) encapsulated between curved front (242) and backside (243) mold portions in accordance with the disclosure. To provide optical isolation the HUD substrate (241) is immersed in air and separated from the mold portions by spacers (245). A HUD encapsulated within planar front (252) and backside (253) molded portions is shown in FIG. 16, in accordance with other examples. The HUD substrate may support both the metalens array and the reflection grating.

The metalens elements may be configured to enable the control of polarization. In some examples, polarization control is provided using the orientations of arrays of elements, e.g., identical elements. The metalens array may be configured to provide a retarder and/or but not limited to, a predefined output polarization from the display. In some cases, the metalens element is configured to have high diffraction efficiency for one of two orthogonal polarization components, and low diffraction efficiency for the other polarization, or high diffraction efficiency for all polarization components.

In some examples, the metalens element is configured to be mechanically deformable to adjust focus and/or correct aberrations.

The display may integrate an electrochromic film for modifying the color or opacity of the display using an applied voltage. In some examples the electrochromic film window blocks ultraviolet, visible, or (near) infrared light instantaneously and on demand. The electrochromic film may be integrated into the displays as part of a casting process.

In some examples, a HUD based on the above-described examples provides a field of view of about 30° H×20° V, an eyebox of about 75 mm× about 100 mm, eye relief in the range about 150—about 9.5 mm, a viewing distance of about 150 mm, a substrate thickness about 0-about 15 mm., an active area of about 150 mm× about 200 mm, and an image at infinity.

The disclosure is also directed to a visor for use with helmets and other head-worn equipment. These visors make use of the features discussed in relation to displays which are HUDs. In some examples, the visor employs a curved substrate, i.e., the reflection grating and metalens are integrated within the curved substrates or on a surface thereof. Curved substrates present challenges in transparent display design, particularly where a wide field of view and a large eyebox are provided simultaneously. Curved surfaces typically destroy collimation, and can lead to aberrations, illumination non uniformity, and/or eye glow. The correction functions used to reduce the aberrations and illumination non-uniformity can vary in a non-linear fashion along the substrate. In some examples, a combination of optical and electronic correction functions are used to compensate for the aberrations and non-uniformities. Since the beam in the substrates interacts with curved surfaces, some degree of focus correction may also be performed.

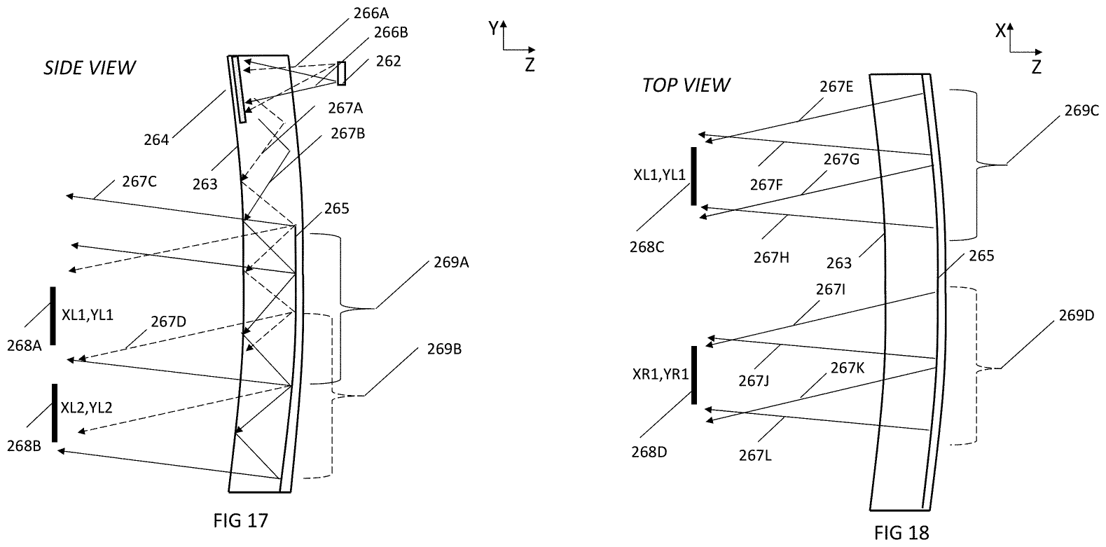

A curved visor combiner display in side and plan views in accordance with some examples of the disclosure. A side view of the visor shown in FIG. 17 includes an array of microLED panels (262), a curved transparent optical substrate (263), an array of reflection metalenses (264) and a reflection hologram foil (265) embedded within the substrate. Ray paths (266A, 266B) from the microLED panel are collimated by the metalens and coupled into total internal reflection paths (267A, 267B) towards the reflection hologram which beam expands the guide light in at least one direction and diffracts the light out of the substrate into collimated beam directions 267C, 267D across a field of view. Vertical TIR region (269A) of the substrate directs image light to pupil position XL1,YL1 (268A) and the vertical TIR region (269B) of the substrate directing image light to pupil position XL1,YL1 (268B).

The horizontal regions of the substrate providing imagery viewed at pupil positions XL1, YL1 (268C) and XL1, YL1 (268D) is shown in FIG. 18. The portions of the visor (269C, 269D) are primarily responsible for directing image light into ray paths (267E-267H) towards the left eye pupil (268C) and for directing image light into ray paths (267I-267L) towards the right eye pupils (268D). Unlike the vertical expansion function, horizontal pupil expansion is provided by the use of multiple microLED panels as discussed above.

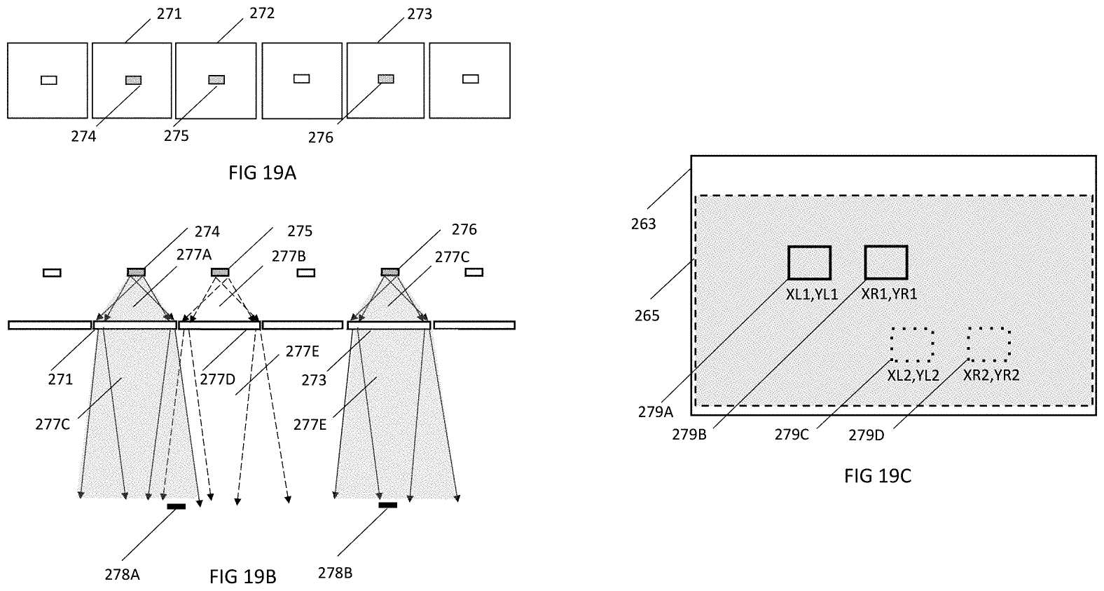

A front elevation view of the microLED array and metalens array is shown in FIG. 19A in accordance with some examples showing metalens elements (271-273) overlapping microLED panels (274-276). An unfolded view shown in FIG. 19B delineates the optical paths from the microLED panels through the metalens elements to the eye pupils, via the substrate (which is not shown) in accordance with some examples. Examples of divergent beams (277A, 277C) emanating from activated microLED panels (274, 276) are shown with solid lines and shaded beam cross sections. The collimated light (277C, 277E) from the activated microLED panels may be viewed at pupil positions 278A, 278B, for example. In some examples, a pupil may receive light from more than one microLED panels with the contribution of image light from microLED 275 to the pupil 278A being indicated by the dash line rays 277B, 277D. FIG. 19C conceptually illustrates a front view of the visor substrate in accordance with some examples. The left and right eye pupil configurations (279A, 279B) for a first viewing positions (also labelled by XL1, YL1 and XR1, YR1) and the left and right eye pupil configurations (279A,279B) for a first viewing positions (also labelled by XL1, YL1 and XR1,YR1) are shown.

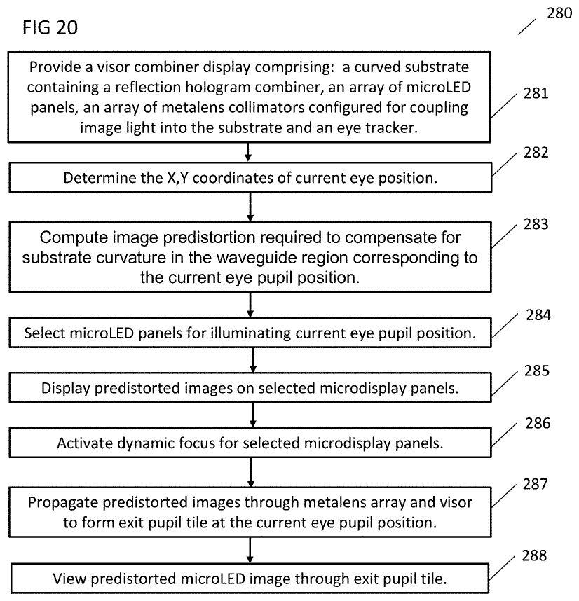

An exemplary method for displaying an image using a holographic visor combiner including microLEDs and metalenses is shown in FIG. 20 in accordance with an example of the disclosure. Method (280) includes providing (281) a visor combiner display including: a curved substrate containing a reflection hologram combiner, an array of microLED panels, an array of metalens collimators configured for coupling image light into the substrate and an eye tracker. The eye tracker may include infrared sources, infrared sensors and a processor. The X, Y coordinates of current eye pupil positions, for at least one eye, are determined (282), e.g., using the eye tracker. The image predistortion to compensate for distortions arising from the substrate curvature in the substrate region corresponding to the current eye pupil position are computed (283). MicroLED panels illuminating the current eye pupil position are selected (284) for the display of predistorted imagery. The predistorted images are computed and displayed (285) on the selected microdisplay panels. Dynamic lens elements for applying focus corrections are activated (286) for the selected microdisplay panels. The predistorted images are propagated (287) through metalens array and visor substrate to form an exit pupil tile at the current eye pupil position. The predistorted microLED image may be viewed (288) through the exit pupil tile.

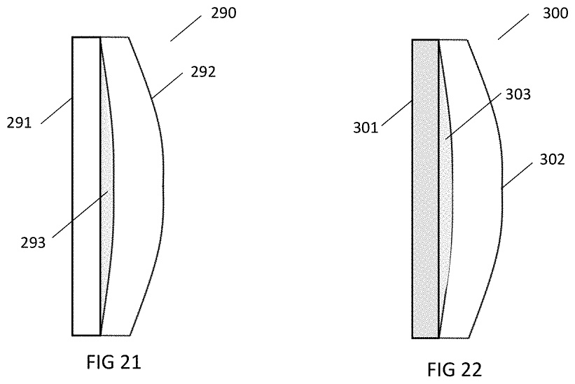

A dynamic focus lens may be provided between each microLED panel and its corresponding metalens element to provide focal adjustment for each pupil location to compensating for defocusing by the curved faces of the visor. The focal setting depends on the eye pupil position as determined by the eye tracker. A dynamic lens may be based on combining two refractive optical elements with a liquid crystal layer arranged between and conformed to the shapes of the refractive lens surfaces, the liquid crystal layer providing changes in optical power in response to a voltage applied across the lens assembly. FIG. 21 is a cross section view of a dynamic lens (290) including a first refractive lens (291) and a second refractive lens (292) on opposing sides of a liquid crystal lens layer (293).

In some examples, a dynamic lens is based on the combination of a refractive element and a diffractive lens arranged on opposing sides of a liquid crystal lens layer. The diffractive lens may be a Fresnel lens, a holographic optical element (HOE) or a metalens. A dynamic lens (300) provided by a metalens (301) and a refractive lens (302) arranged on opposing sides of a liquid crystal lens layer (303) in accordance with some examples is shown in FIG. 22. In some examples, the metalens of FIG. 22 includes a curved surface.

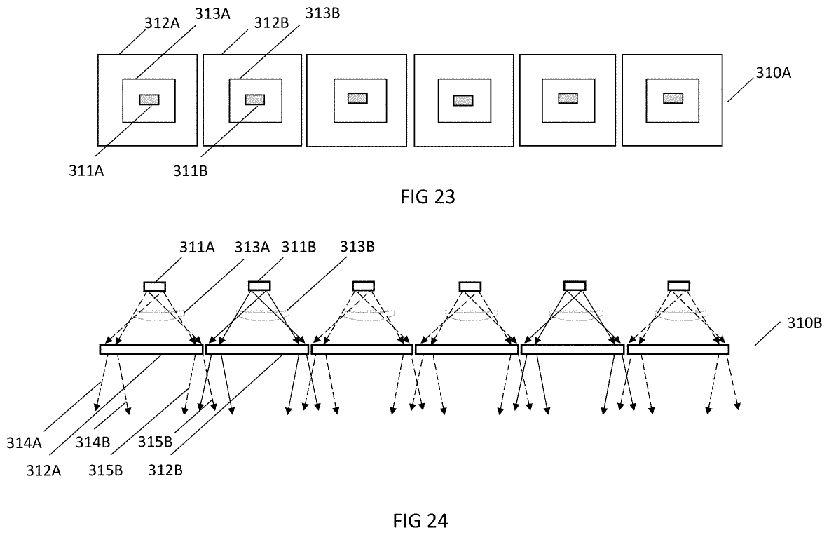

A front elevation configuration of an optical assembly including microLED array elements, a metalens array and a dynamic lens array is shown in FIG. 23. The assembly includes metalens elements (312A, 312B), overlapping microLED panels (311A, 311B) and the dynamic lens elements (313A, 313B) in accordance with some examples. A plan view of the components of FIG. 23 in accordance with some examples is shown in FIG. 24 which illustrates ray paths (314A-314D) through the dynamic lens array and the multiplexed metalens array.

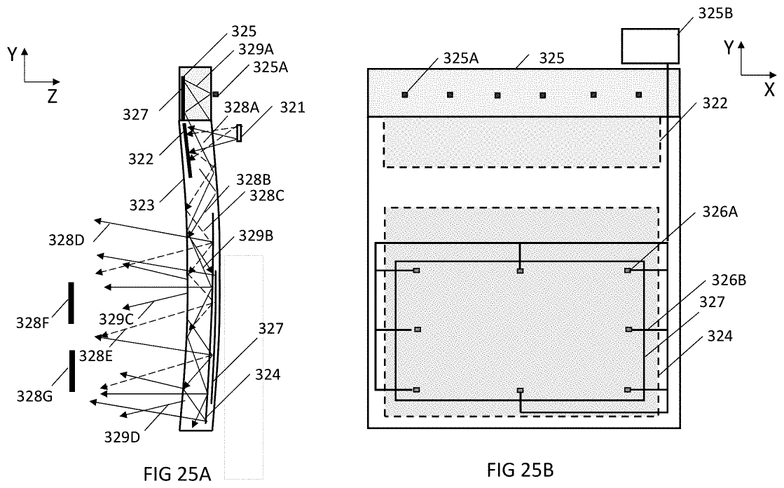

A side elevation view of an exemplary visor incorporating an eye tracker is shown in FIG. 25A. The visor includes an array of microLED panels (321) a reflective metalens element (322) embedded in the substrate (323) and a reflection hologram (324) embedded in the substrate. The eye tracker (325) includes infrared emitters (325A) and a signal processor (325B). Multiple miniature cameras (326A) disposed within the reflection HOE area (324) and connected to the processor by camera circuitry are illustrated by the circuit lines (326B). The electronic devices may be powered, e.g., by conventional or solar batteries connected via conductive printed circuits. A separate IR reflection HOE (327) overlays the visor reflection HOE to direct infrared radiation toward the eyes of the user. The optical path of image light from the microLEDs to the viewing region are represented by the rays 328A-328E which enter the left and right eye locations (328F, 328G). The paths of infrared radiation from the infrared emitters to the viewing region are represented by the rays 329A-329D. In some examples, the eye tracking electronic circuitry may be surface mounted on a face of the visor using NanoWeb™ nanowire technology manufactured by Metamaterial Inc.

In some examples, the disclosure provides a visor for attachment to a helmet. The visor may provide a field of view of about 40° diagonal. The field of view may have an aspect ratio of about 16:9. The field of view may have an aspect ratio of 4:3. The image may be displayed in landscape format or portrait format. A luminance in excess of 3,000 nits may be provided at the eyebox. The visor substrate may have a thickness in the range of about 8 mm to about 10 mm. The visor has a radius of curvature of about 100 mm. in the horizontal plane. The eye box may have dimensions of about 15 mm× about 10 mm. in either landscape or portrait format. An exemplary visor may provide an eye relief of about 30 mm. The visor may provide a monochrome display. The above specification may be achieved using a six microLED array (each device having a specification similar to the Jade Bird J013G01VGA) 3.5×10⁶ nits luminance, 640×480 pixel resolution device.

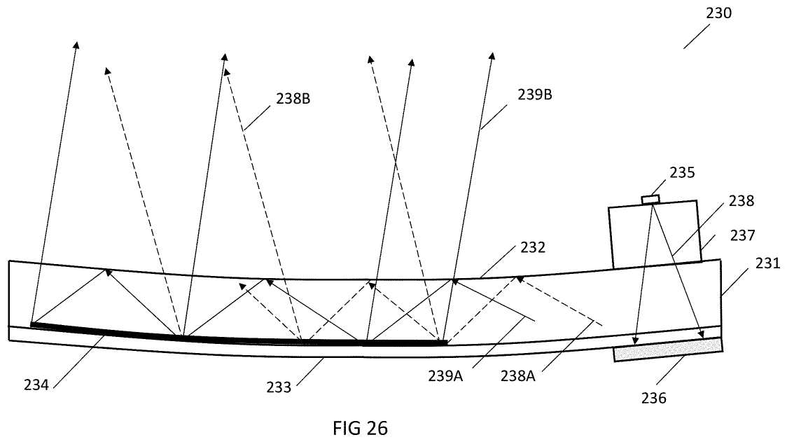

As discussed above, a combiner display may be integrated within a curved visor. In some examples, the reflection grating may be formed as a foil or on a substrate that is encapsulated within the visor using a casting process. FIG. 26 conceptually illustrates, in cross section, a visor (230) formed from upper (232) and lower (233) encapsulation substrates arranged on opposing sides of a reflection hologram layer (234) according to some examples. The display further includes a microLED panel array (235) and a reflective metalens array (236). The display may further include an optical substrate (237) located between the microLED panel array and the upper encapsulation substrate. Typical ray paths from a microLED panel to the eyebox of the visor are represented by exemplary ray paths (238, 238A, 238B and 239A, 239B).

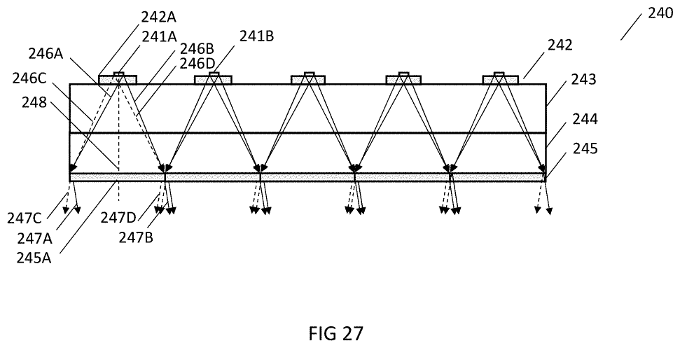

In some examples, light collection efficiency for microLEDs is improved using compact condenser lenses positioned on top of the emissive surface of each microLED. FIG. 27 conceptually illustrates a microLED substation (240) in cross-section that improves light collection efficiency in accordance with some examples. The apparatus includes an array of microLED panels (241A), an array (242) of metalenses condenser lens elements (242A) overlaying the microLED panels and supported by the optical substrate (243). The apparatus further includes an array (245) of metalenses supported by a substrate (243) for collimating the light from each microLED panel. A single substrate may be used to support both metalens condenser lens array and the d metalens array. Rays 246A-246D and 247A-246D from the edges of the microLED panel (241A) to the output collimated beam region of a multiplexed metalens element 244A are shown. The condenser array may also be used for shaping at least one of the beam cross section and light intensity variation across the beam.

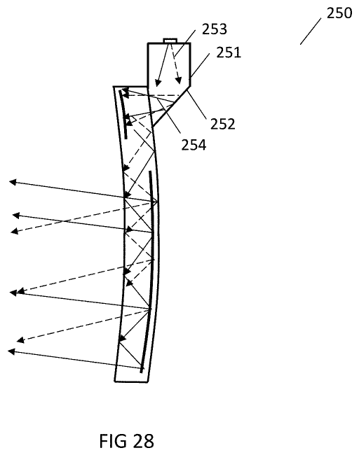

The disclosure provides a more compact visor display which may employ prismatic input coupling optics. FIG. 28 conceptually illustrates in cross section a visor (150) using prismatic input coupling optics in accordance with some examples. The configuration of the metalens and reflection gratings is similar to the example of FIG. 17. The coupling prism (251) includes a tilted mirror surface 252 for reflecting rays (253) emitted by the microLED panel array into ray directions (254) towards the metalens arrays. From consideration of FIG. 17 and FIG. 28, the coupling prism allows a longer input optical path in glass allow horizontal beam expansion to be accomplished with fewer lens and without increasing the display optical thickness at the input end of the substrate. From consideration of FIG. 28 in relation to the earlier described examples, and after some first order optical analysis, by folding the input path in this way the number of microLED elements to achieve the above specification for a 3000 nit display may be reduced from about 6 to about 4 (assuming F/number 0.9-1.2).

A visor substrate based on the above-described examples may be configured in a wide range of geometries to meet differing ergonomic and aesthetic requirements.

The visor may include composite curves. At least one surface of the visor may include at least one planar facet, and/or at least one surface of the visor may be formed with two or more different surface curvatures. The visor may have spatially varying thickness. Various examples include portions having cylindrical symmetry, and/or may include freeform curves.

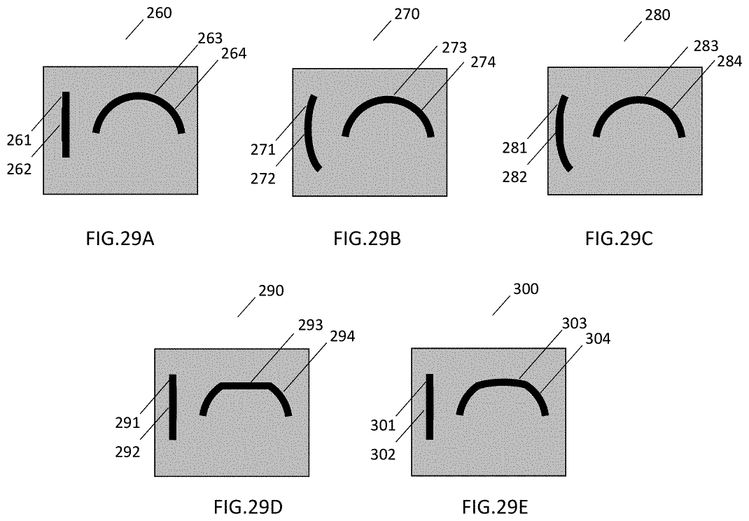

An exemplary cylindrical visor (260) delineated in FIG. 29A, shows the viewing region (262) and surrounding substrate (261) in a side-cross-section view and showing the viewing region (263) and surrounding substrate (264) in a plan cross section view.

FIG. 29B illustrates an exemplary visor (270) formed from two principal curves showing the viewing region (272) and surrounding substrate (271) both having a first curvature in a side cross section view and showing the viewing region (273) and surrounding substrate (274), both having a second curvature in a plan cross section view.

FIG. 29C illustrates an exemplary visor (280) providing a cylindrical viewing region with the surrounding regions have two different curvatures, showing the viewing region (282) and surrounding substrate (281) and showing the viewing region (283) and surrounding substrate (284).

FIG. 29D illustrates an exemplary visor (290) providing a flat viewing region with the surrounding regions having cylindrical geometry, showing the viewing region (292) and surrounding substrate (291) and showing the viewing region (293) and surrounding substrate (294).

FIG. 29E conceptually illustrates an exemplary visor (300) providing a viewing region with a shallow curvature with the surrounding regions having cylindrical geometry showing the viewing region (302) and surrounding substrate (301) and showing the viewing region (303) and surrounding substrate (304) in accordance with some examples. In each of the above examples (FIGS. 29A-29E), the side cross-section view lies in the vertical plane of symmetry of the visor.

Visors including any of the surface forms discussed above may embed metalens and reflection HOE films or substrates. The microLED array may be embedded within the substrate. Visors according to the principles discussed above may be formed using a casting process as described above.

Other examples besides those discussed in relation to microLED panels, may implement or use alternative display technologies such as, but not limited to, liquid crystal displays, micro electromechanical displays, and laser scanners.

The various designs discussed herein can include a GRIN (graded index) lens array, e.g., as an alternative or addition to using a metalens array, to project image light from an array of microLEDs. GRIN lens arrays offer a shorter time-to-market alternative to metalens solutions. Following the above-described embodiments, a GRIN display implementation may include an eye tracker to determine gaze direction and pupil center position. Eye tracking can reduce the number of microLEDs that are active at any time.

Various GRIN lens configurations are useful in the displays provided herein. For example, a GRIN lens can provide a single lens replacement for a multi element refractive design. In some examples, a hybrid solution including a conventional refractive element, at least to provide improved monochromatic aberration correction and chromatic aberration correction, may be used along with a GRIN lens. In various examples, a hybrid GRIN and diffractive solution are used, at least to provide a higher degree of monochromatic and chromatic correction. In various examples, a hybrid GRIN and metalens solution are used to provide a higher degree of monochromatic and chromatic correction. In some examples, a hybrid solution, further including at least one freeform refractive surface is useful. In various examples, a hybrid solution further including a reflective surface is useful.

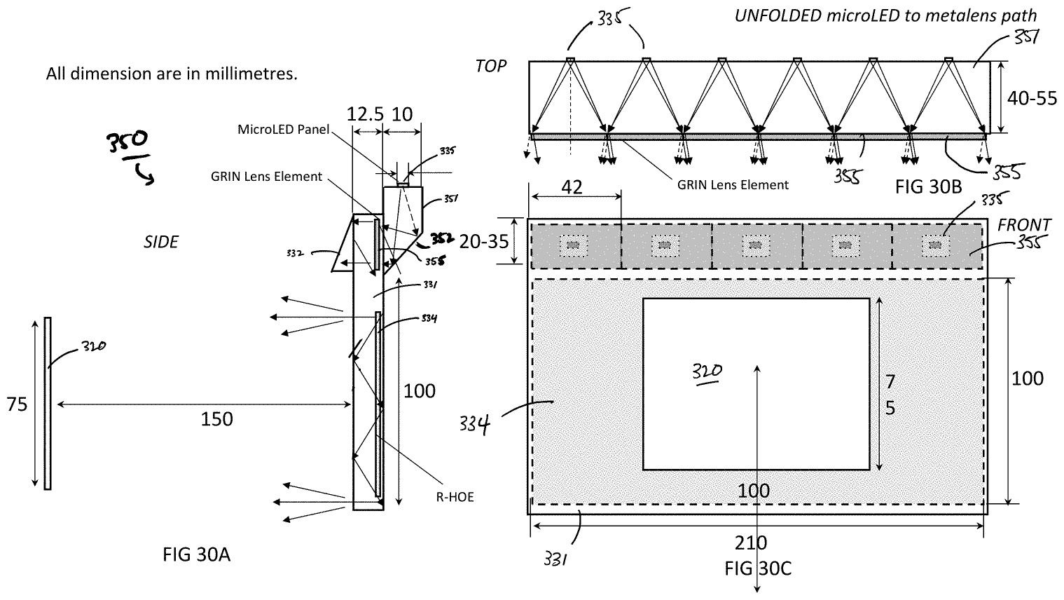

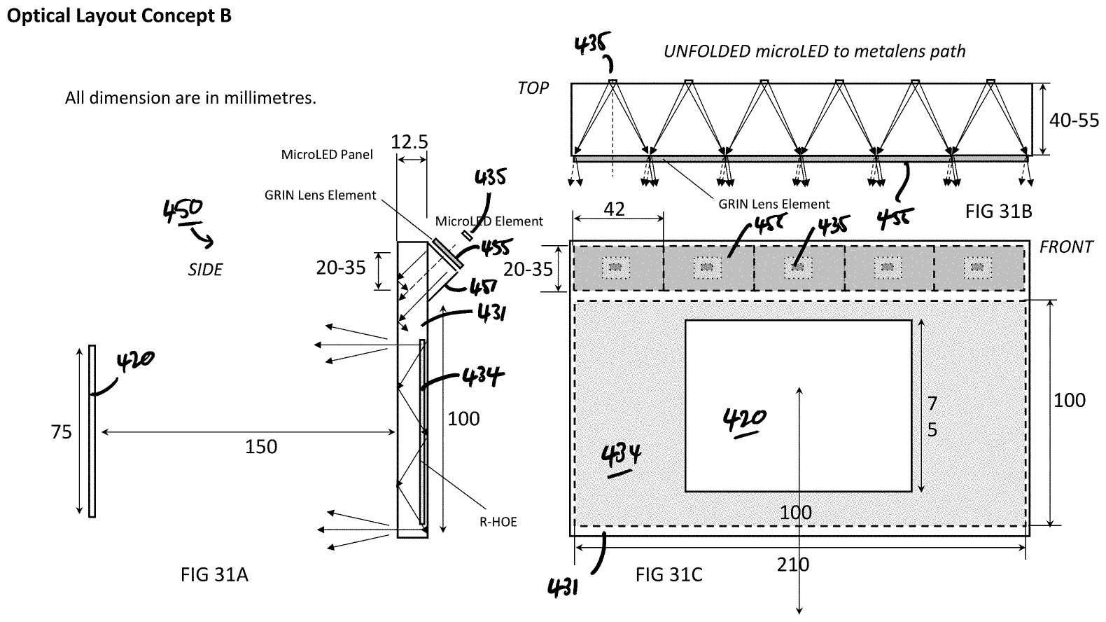

FIG. 30A conceptually illustrates in cross section a visor (350) using prismatic input coupling optics in accordance with some examples. A coupling prism (351) includes a tilted mirror surface (352) for reflecting rays emitted by a microLED panel 335 array into towards a GRIN lens (355) array. The coupling prism enables a longer input optical path in glass, and enables horizontal beam expansion to be accomplished with fewer lenses and without increasing the display optical thickness at the input end of the substrate. Visor (350) also includes a optical substrate (331) with a reflection hologram layer (334). A second prism 332 directs light received from the GRIN lenses (335) into the optical substrate (331) towards the reflection hologram layer (334), which directs the light out of the optical substrate filling an exit pupil (320). FIG. 31B shows an unfolded view of the optical path between the microLED panels 335 and the GRIN lenses 355. A front elevation of the visor (350) is shown in FIG. 31C.

Other arrangements utilizing GRIN lenses are possible. For example, FIGS. 31A-31C show another visor (450) with a GRIN lens (455) array arranged to received light directly (i.e., with no intervening optical elements) from a microLED panel (435) array. A prism (451) is arranged to couple light from the GRIN lenses (455) into the optical substrate (431). A reflection hologram layer (434) in the optical substrate (431) directs the light out of the substrate to an exit pupil (420).

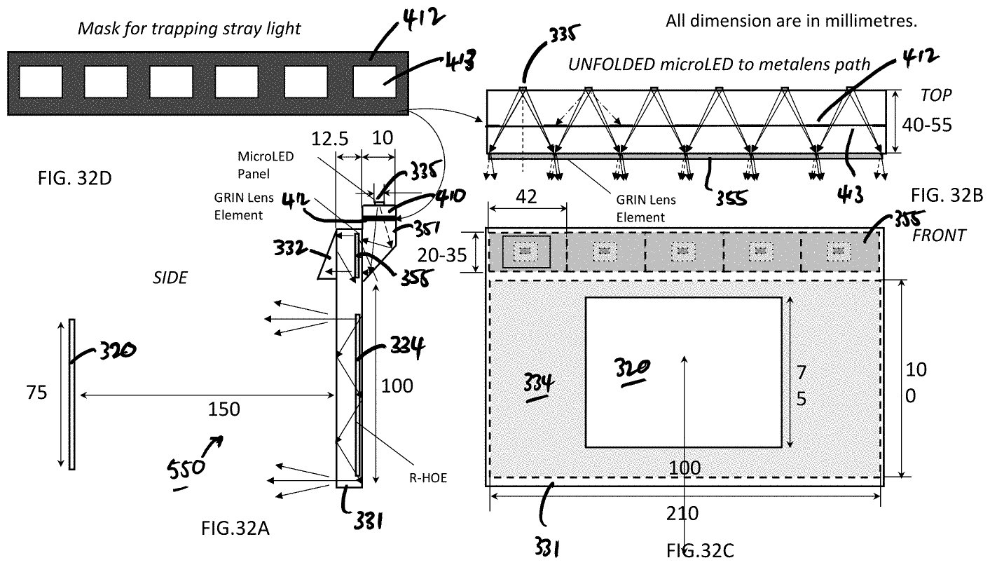

A further example is shown in FIGS. 32A-32D in which a visor (550) includes a mask layer (412) for trapping stray light. As depicted, visor (550) includes the same components as visor (350) along with mask layer (412) and a spacer layer (410) arranged between the microLED panels (335) and prism (351). Mask layer (412) is composed of an opaque material (e.g., a light absorbing material) and defines an array of apertures through which light from the microLED panels can pass.

The GRIN lenses may be configured as an array of identical collimator lens elements of identical optical prescription is shown in FIGS. 30A-32C. In the examples shown in FIGS. 30A-32D, the GRIN lens array is composed of a 1×5 array of rectangular aperture elements, each of size about 42 mm× about 20 mm. Dimensions for other components are provided in mm. However, these dimensions are examples and other array sizes and/or other element dimensions are possible.

In some examples, one or more of the GRIN lens elements are configured as a nanolayered GRIN singlet equivalent to a multi-element refractive projection lens. Such a GRIN singlet may be equivalent to an about 3 to about 4 element refractive projection lens with a field of view of at least about 40 degrees. Each GRIN lens element may be about 5 mm to about 10 mm in thickness, for example.

Correction of monochromatic (e.g., but not limited to green) aberrations (with, e.g., but not limited to, the aid of an additional refractive and/or diffractive element), is useful in many HUD applications. In some examples, the GRIN lens design is translatable to a single element full color imaging solution (or at least a compact hybrid solution using refractive/diffractive elements). In some examples, a GRIN lens supports an AR coating. In some examples, the GRIN lens design has an axisymmetric form, although it may be cut to a non-circular shape (e.g., a rectangular shape). In some cases, GRIN lens elements can have an anamorphic form. In some examples, a GRIN HUD lens array has relaxed lateral tolerances as the GRIN lenses are intended for pupil replication rather than field of view tiling.

### EQUIVALENTS

Although various features of the present disclosure have been presented separately (e.g., in separate figures), the skilled person will understand that, unless they are presented as mutually exclusive, they may each be combined with any other feature or combination of features of the present disclosure. Whereas the disclosure has been described in relation to what are presently considered to be practical and useful examples, it is to be understood that the disclosure is not limited to the disclosed arrangements but rather is intended to cover various modifications and equivalent constructions included within the spirit and scope of the disclosure. Such equivalents are intended to be encompassed in the scope of the following claims.

1. A display comprising:
an optical substrate;
a first display panel;
a second display panel;
a first metalens element configured to collimate and project image light from the first display panel into a first optical path in the optical substrate during operation of the display;
a second metalens element configured to collimate and project image light from the second display panel into a second optical path in the optical substrate during operation of the display; and
a reflector configured to direct image light from the substrate into an exit pupil of the display during operation of the display.

2. The display of claim 1, wherein the display is configured so that, during operation, the first display panel emits light of a first wavelength in a first field of view (FOV) for viewing through a first portion of the exit pupil, and the second display panel emits light at the first wavelength in the first FOV for viewing through a second portion of the exit pupil.

3. The display of claim 1, wherein the display is configured so that, during operation, the first display panel emits light of a first wavelength in a first FOV for viewing through the exit pupil, and the second display panel emits light at a second wavelength in the first FOV for viewing through the exit pupil.

4. The display of claim 1, wherein the display is configured so that, during operation, the first display panel emits light of a first wavelength in a first FOV portion for viewing through the exit pupil, and the second display panel emits light at the first wavelength in a second FOV portion for viewing through the exit pupil.

5. The display of claim 1, wherein the first metalens element is configured to provide a first beam expansion.

6. The display of claim 1, wherein the reflector is configured to provide a beam expansion in one direction.

7. The display of claim 5, wherein the first metalens element is configured to provide a first beam expansion, and the reflector is configured to provide a second beam expansion orthogonal to the first beam expansion.

8. The display of claim 1, wherein the first and second metalens elements abut one another, are stacked relative to one another, are multiplexed, comprise interspersed diffracting features, and/or form part of a two-dimensional array.

9. The display of claim 1, wherein at least one of the first and second metalens elements is configured as a conformal layer on a curved surface, coated with a reflective material, characterized by a prescription for diffracting infrared wavelengths, integrated within a cast lens, in optical contact with a liquid crystal layer, backfilled with liquid crystal, a Pancharatnam-Berry metalens, a geometric phase metalens, and/or a nanostructure comprising fins.

10. The display of claim 1, wherein at least one of the first and second metalens elements is fabricated by a UV lithographic process, a deep UV lithographic process, and self-organization of a mixture of at least one monomer and at least one inert material.

11. The display of claim 1, wherein the display is a light field display.

12. The display of claim 1, wherein the reflection grating comprises a nanostructure element, an array of nanostructured elements, and/or a stack of elements, each element configured for a different wavelength emitted by the microLEDs.

13. The display of claim 1, wherein at least one of the first and second metalens elements and the reflector are formed on a common surface.

14. The display of claim 1, wherein the first and/or second metalens elements is formed on a first substrate, and the reflector is formed on a second substrate different from the first substrate.

15. The display of claim 1, wherein the first and/or second metalens elements are configured according to a prescription selected from the group consisting of correcting aberrations, diffracting infrared light, and modifying polarization.

16. (canceled)

17. (canceled)

18. The display of claim 1, wherein the display comprises a transparent display.

19. (canceled)

20. The display of claim 1, wherein the optical substrate is curved in at least one plane, wherein, during operation, the first display panel is configured to display a first image predistorted for viewing through a first portion of the exit pupil, and the second display panel is configured to display a second image predistorted for viewing through a second portion of the exit pupil.

21. The display of claim 1, further comprising at least one dynamic lens.

22. (canceled)

23. (canceled)

24. (canceled)

25. The display of claim 1, wherein at least one of the first display panel, the second display panel, the first metalens element, the second metalens element, and the reflector, is/are embedded within a substrate formed using a casting process.

26. (canceled)

27. The display of claim 1, further comprising an opaque layer of an opaque material and defining a first aperture and a second aperture, the opaque layer being arranged between the first and second display panels and the optical substrate, a center of the first aperture lying on a center beam axis of the first display panel, and a center of the second aperture lying on a center beam axis of the second display panel, the first aperture and the second aperture being configured to prevent a beam from the first display panel from overlapping with a beam from the second display panel during operation of the display.

28-43. (canceled)
